(19) United States
(12) Patent Application Publication
(10) Pub. No.: US 2020/0167832 A1
(43) Pub. Date: May 28, 2020

(54) GENERATING ADVERTISEMENTS ON THE FLY WITH A FEEDBACK LOOP

(71) Applicant: International Business Machines Corporation, Armonk, NY (US)

(72) Inventors: Florian Pinel, New York, NY (US); Robert N. Redmond, Smyrna, GA (US); Paul M. Matchen, Bethel, CT (US); Donna K. Byron, Petersham, MA (US)

(21) Appl. No.: 16/202,167

(22) Filed: Nov. 28, 2018

(51) Int. Cl. G06Q 30/02; G06T 11/00; G06T 11/40

(52) U.S. Cl. CPC G06Q 30/0276; G06T 11/40; G06T 11/001; G06Q 30/0247

(57) ABSTRACT

Machine logic (for example, software) for creating layout for an advertisement and choosing a color scheme, with good color harmony, for the advertisement. Some embodiments are directed to testing how well people respond to advertisements laid out and colored created by the machine logic.

### BACKGROUND

The present invention relates generally to the field of designing advertisement displays to be distributed to potential customer devices (for example, smart phones, laptops) over communication networks. Serving multiple versions of a same ad and comparing each version's performance has become common practice. Sometimes, the different versions are based on our assumptions of how users will be influenced by the context (demographics, surrounding contents, or external elements such as weather or trends).

It is known to serve (that is, distribute over a communication network to devices of potential customers) multiple versions of an advertisement that: (i) all have the same visual content (that is, graphics, text, video) within the boundaries of the ad (for example, rectangle boundary for a rectangle shaped ad; but (ii) different layout, color scheme, relative sizes of various visual elements, fonts, etc. It is further known to compare each version's performance, typically by one or more of the following performance parameters: (i) click-throughs (that is, the action or facility of following a hypertext link to a particular website, especially a commercial one); (ii) viewability (that is, an online advertising metric that aims to track only impressions that can actually be seen by users—for example, if an ad is loaded at the bottom of a webpage but a user doesn't scroll down far enough to see it, that impression would not be deemed as positively contributing to viewability); (iii) hover (that is, an amount of time a user hovers a cursor over a display of an advertisement); and/or (iv) non-action impressions (that is, when an ad is not clicked upon, but is fetched from its source and is countable—typically each time an ad is fetched, it is counted as one impression.

For purposes of this document: (i) “memorability” is hereby defined as the quality or state of being easy to remember or worth remembering; and “image memorability” is hereby defined as the quality or state of a visual element (for example, photo, video or visually-displayed text) or visual presentation (for example, an on-line advertisement containing a set of visual elements being arranged relative to each other in a visual composition) of being easy to remember or worth remembering.

For purposes of this document, “color harmony” is hereby defined as the property that certain aesthetically pleasing color combinations have. Harmonious combinations of colors create aesthetically pleasing contrasts and consonances. For example, some of these combinations may be characterized by complementary colors, split-complementary colors, color triads, or analogous colors. Artists and designers typically make use of these harmonies in order to achieve certain moods or aesthetics.

Hill climbing is a type of mathematical algorithm. In numerical analysis, hill climbing is a mathematical optimization technique. Hill climbing belongs to the family of local search. Hill climbing is an iterative algorithm that starts with an arbitrary solution to a problem, then attempts to find a better solution by making an incremental change to the solution. If the change produces a better solution, another incremental change is made to the new solution, and so on until no further improvements can be found. Hill climbing finds optimal solutions for convex problems. For other problems hill climbing algorithms will find only local optima (solutions that cannot be improved upon by any neighboring configurations). These local optima are not necessarily the best possible solution (that is, not necessarily the global optimum) out of all possible solutions (the search space). The simplicity of hill climbing makes it a popular first choice among optimizing algorithm types. It is used widely in artificial intelligence, for reaching a goal state from a starting node. Hill climbing can often produce a better result than other algorithms when the amount of time available to perform a search is limited, such as with real-time systems, so long as a small number of increments typically converges on a good solution (the optimal solution or a close approximation).

The article “Winning the Online Shopping Festival Race by Cognitive Advertising” dated Jun. 7, 2016 and written by Vikram Mohan states as follows: “To offer a rich and compelling brand experience to consumers, it is imperative to personalize the creative at an individual impression level which further enhances the need to develop a humongous set of creative materials. Retailers are yearning for an innovation that reduces the creative production spends and increases speed to market. The solution: Cognitive Advertising . . . . The answer lies in applying Cognitive solutions to Digital Advertising. Cognitive Powered Dynamic Creative Optimization (DCO) which allows marketers to break an ad into individual pieces and create different versions for different audiences. Each ad uses a template of one to four dynamic elements related to variables such as content, visual and calls to action. These are then dynamically assembled to serve up a customized ad based on unique user attributes. The live audience data from the ad exchange is fed into a DCO platform that serves as the decision criteria for restructuring the creative. This data can be augmented over time using personality insights, text analytics and weather APIs from IBM Watson thereby increasing the CTR and conversion rates of display advertising. The auto learning capabilities of Watson and algorithmic improvements over time aid in enhancing the data which can then be used to optimize creative choices according to campaign objectives . . . . The marketer can create thousands of customized ads on the fly, without having their creative department create every combination.”

### SUMMARY

According to an aspect of the present invention, there is a computer implemented method, computer program product and/or computer system for preforming the following operations (not necessarily in the following order): (i) receiving a visual elements data set including a plurality of visual elements for a first advertisement; (ii) determining, by machine logic, a set of layout(s) for the plurality of visual elements; (iii) determining, by machine logic, a set of color scheme(s) including a plurality of colors, where each color scheme has a color harmony value that is relatively large; (iv) for each given layout of the set of layout(s) and each given color scheme of the set of color scheme(s), coloring, by machine logic, the given layout according to the given color scheme to generate a set of colored first advertisement version(s); and (v) testing the performance of the set of colored first advertisement version(s).

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a screenshot view of a first version of a first advertisement generated by the first embodiment system;

FIG. 4B is a screenshot view of a second version of the first advertisement generated by the first embodiment system;

FIG. 4C is a screenshot view of a second version of the first advertisement generated by the first embodiment system;

FIG. 5 is a flowchart showing a second embodiment method according to the present invention; and

FIG. 6 is a flowchart showing a third embodiment method according to the present invention.

### DETAILED DESCRIPTION

Some embodiments of the present invention are directed to machine logic (for example, software) for creating layout for an advertisement and choosing a color scheme, with good color harmony, for the advertisement. Some embodiments are directed to testing how well people respond to advertisements laid out and colored created by the machine logic. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

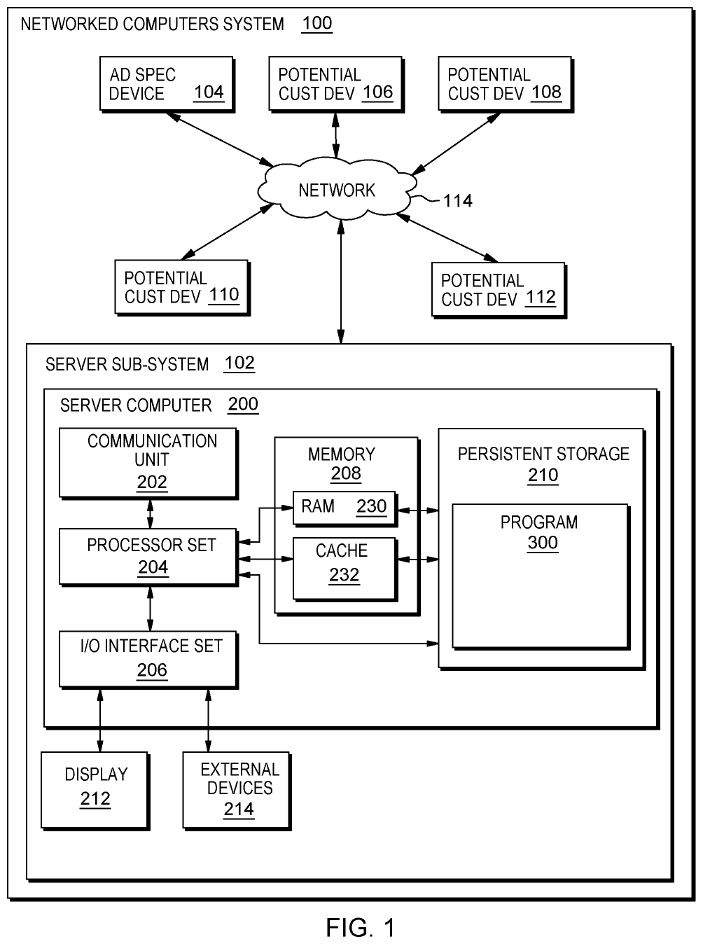

An embodiment of a possible hardware and software environment for software and/or methods according to the present invention will now be described in detail with reference to the Figures. FIG. 1 is a functional block diagram illustrating various portions of networked computers system 100, including: server sub-system 102; ad specification device 104; potential customer devices 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

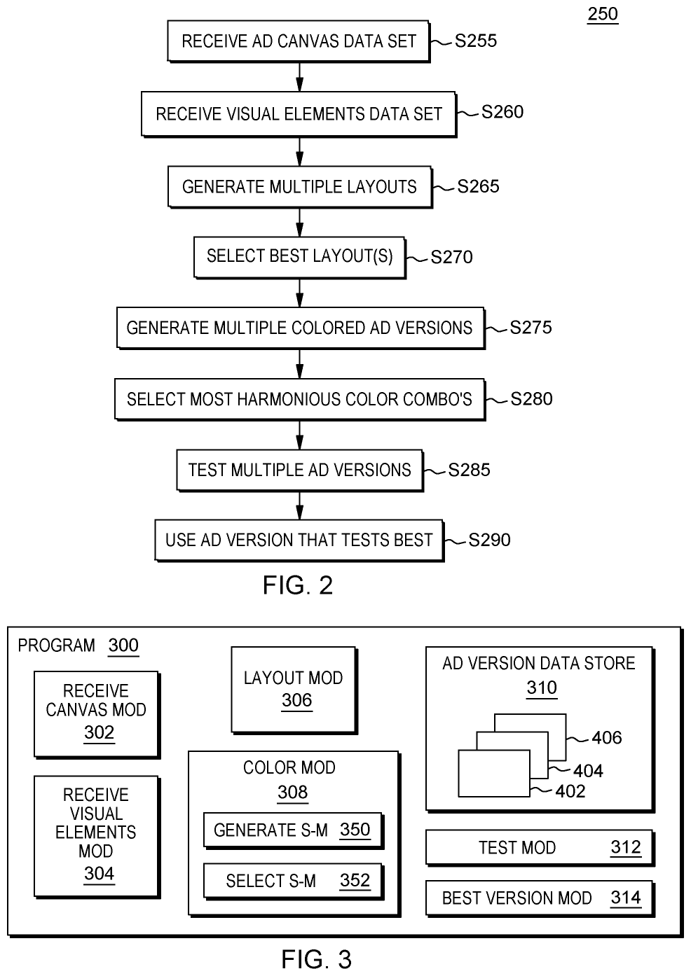

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255 ad specification device 104 (see FIG. 1) sends an ad canvas data set through communication network 114 to receive canvas module (“mod”) 302 of program 300. In this example, the ad canvas data set includes data indicative of: (i) the shape of a proposed new advertisement (in this example, a rectangle); (ii) the size of the proposed new advertisement (in this example, 1000 pixels horizontal by 50 pixels vertical); and (iii) a background color or pattern for the new advertisement (in this example, transparent). In this example, the ad canvas data set is sent at the time that a new advertising client (in this example, Joe's Diner) orders a new advertisement to be made and distributed to potential customers as an advertisement on various websites (for example, news sites, blogs, search portals, etc.). Alternatively, the process may be started at the time that there is a request to download an advertisement as part of a web page display that is being built for a specific potential customer. In this example, the canvas size and shape are determined before, or at the same time, that the content (that is, visual elements) of the advertisement are received. Alternatively, the size and shape of the ad may not be decided until the visual elements are laid out and/or colored.

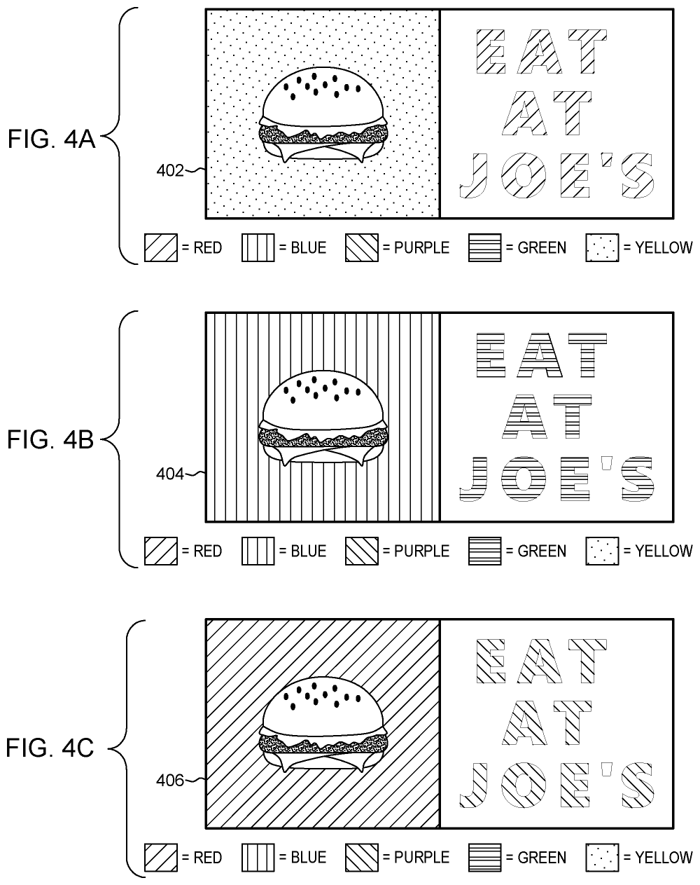

Processing proceeds to operation S260, where receive visual elements mod 304 receives the visual elements of the ad over communication network 114 from ad specification device 104. In this simple example, and as shown in FIGS. 4A to 4C, the advertisement has two visual elements: (i) a photographic image of a turkey burger with iceberg lettuce on a whole grain bun; and (ii) and text that says, “EAT AT JOE'S.” Besides text and graphics, other possible types of visual elements may include video's, “gif's,” buttons (or other interactive visual features) and/or masks (that is graphics and/or patterns overlaid over other visual elements).

Processing proceeds to operation S265, where machine logic of layout mod 306 automatically creates alternative layouts of the visual elements within the boundaries of the canvas. Because of the size and/or shape of the two visual elements and the size and shape of the canvas, there are only two possible layouts in this simple example: (i) the layout shown in FIGS. 4A to 4C with the burger on the left and the slogan on the right; and (ii) an alternative layout with the slogan on the left and the burger graphic on the right. These two layouts are respectively shown in the following two paragraphs.

LAYOUT (i): [(hamburger graphic)∥EAT AT JOE'S]

LAYOUT (ii): [EAT AT JOE'S∥(hamburger graphic)]

In other embodiments of the present invention there will often be a greater number of visual elements and/or many more possible layouts. For example, if the canvas shape were a bit different then it might have been possible to have layouts with the slogan above the hamburger graphic, or with the hamburger graphic above the slogan, or with the hamburger graphic and slogan aligned to be centered about a common diagonal line, etc. Also, when visual elements are allowed to overlap and/or be cropped, this can potentially increase the number of possible layouts. The process of generating possible alternative layouts will be discussed in more detail in the following sub-section of this Detailed Description section.

Processing proceeds to operation S270, where the machine logic of layout mod 306 proceeds to select the best layout from among the possible alternative layouts generated previously at operation S265. In this simple example, the layout mod 306 selects the layout with the burger on the left and the slogan on the right (as shown in each of FIGS. 4A to 4C). In this example, the machine logic uses historical data using the layout of other advertisements, and associated customer reaction testing data, to determine the best layout. Alternatively, the best layout(s) could be selected by a human individual (for example, an expert). Alternatively, this operation can be omitted, and all possible layouts could be used in the operations following operation S270.

Processing proceeds to operation S275, where machine logic of generate sub-mod 350 of color mod 308 generates multiple colored ad version(s) of each of the layout(s) previously selected at operation S270. Each colored ad version will have a different color combination and is stored in ad version data store 310. In this simple example, three different color combinations are generated by generate sub-mod 350: (i) colored ad version screenshot 402 of FIGS. 3 and 4A (also called the yellow-red version); (ii) colored ad version screenshot 404 of FIGS. 3 and 4A (also called the blue-green version); and (i) colored ad version screenshot 406 of FIGS. 3 and 4C (also called the red-purple version).

Processing proceeds to operation S280, where the machine logic of select sub-mod 352 of color mod 308 selects the colored ad version(s) with the largest color harmony value(s) from among the colored ad versions generated previously at operation S275. The machine logic of sub-mod 352 that ensures relatively great color harmony may be color harmony software according to currently existing technology, or color harmony software to be developed in the future. In this simple example, only colored ad version 402 is selected as having the greatest harmony value. Alternatively, more than one colored ad version could be selected for testing and possible large scale use. The machine logic for determining color harmony values for the colored ad versions will be discussed in more detail in the following sub-section of this Detailed Description section.

Processing proceeds to operation S285, where test mod 312 tests the colored ad version(s) (in this simple example, the yellow-red version) using a click through rate (CTR) predictor (not separately shown in FIG. 3). The CTR predictor is trained and re-trained using historical data, to test colored ad version(s). As discussed in the following sub-section, this testing may additionally, or alternatively, include A/B testing.

Processing proceeds to operation S290 where the colored ad version(s) that tests the best is put into larger scale use by best version mod 314. In this simple example, only colored ad version 402 has been tested by the CTR predictor at operation S285, but version 402 has tested sufficiently well so that colored ad version 402 is put into larger scale use by the machine logic of best version mod 314. Various customer engagement parameters, such as click through rate, can be tracked as the use of colored ad version 402 expands.

### III. Further Comments and/or Embodiments

Some embodiments of the present invention recognize the following facts, potential problems and/or potential areas for improvement with respect to the current state of the art: (i) experiments also show that different context-independent combinations of messages, calls to action or colors can perform very differently, even if the designer does not understand the reasons for the results; (ii) it makes sense to generate many versions of a composite ad, where the elements are picked from a small curated pool and assembled in various configurations (sometimes herein referred to as “composition”); (iii) the composition, however, cannot be completely random; and/or (iv) when considering a typical ad with a background image, the overlaid elements (message, call to action, logo) must be positioned and colored with respect to the background.

Some embodiments of the present invention may include one, or more, of the following features, characteristics and/or advantages: (i) dynamically generating composite ads based on demographic characteristics, where the visual elements of the advertisement composition are positioned and modified for color harmony and memorability; (ii) addresses issues of positioning the elements in the composite ad, altering them for color harmonization, and evaluating ad memorability; and/or (iii) uses notion of a “pop-out.”

Some embodiments of the present invention may include one, or more, of the following features, characteristics and/or advantages: (i) a method to generate multiple versions of a composite ad, where each version differs in the way the elements of the ad are combined, positioned, and colored; (ii) ad elements include (but are not limited to): images (background, logos, product images), text messages, calls to action (which can be viewed as images, text, or a combination of both); (iii) when creating a composite ad, the user of our invention specifies the elements of the ad, and provides one or more variations for each element; (iv) several versions of the composite ad are generated, and can be either reviewed by the user, or published directly; (v) as the different versions are served to consumers, machine logic (for example, software) keeps track of click-throughs, viewability, hover and non-action impressions; (vi) based on these statistics, the system can iterate one or more times over the composite ad generation process; and/or (vii) a machine learning model can be trained to predict the performance (for example, click-through rate also known as CTR) of a given version of an advertisement that includes a predetermined set of visual elements.

A method, according to an embodiment of the present invention will now be described in the following paragraphs.

IDENTIFY OVERLAY OPERATION: Identify possible overlay regions by generating a saliency map of the image, and then running segmentation algorithms. Different embodiments then perform various combinations of one or more the following sub-operations: (i) filter out regions whose saliency is over or under a certain threshold; (ii) discard regions that are too small to fit any of the overlaid ad elements; (iii) retain only the largest regions; and/or (iv) discard regions that do not touch one of the borders of the image, or regions that are too far from the center (or central vertical axis, or central horizontal axis) of the image.

GENERATE MAP: Generate map of possible layouts by determining all the combinations of one or more ad elements than can fit in each region. A given layout indicates what elements can fit in what region, and in what sequence. In some embodiments, additional layouts are created by resizing the ad elements, rotating them, or applying other geometric transformations.

GENERATE MULTIPLE VERSIONS: Generate multiple versions of the positioned elements by generating multiple versions of the composite ad using the map of possible layouts. For each layout, arrange the elements within the image region they've been assigned to. Multiple versions can be generated, depending on the horizontal and vertical alignment of the elements.

SELECT HARMONIC SCHEME: Using machine logic that determines color harmony values, select best fitting harmonic template (that is, predetermined combination of colors that exhibit color harmony with each other) for the background image—which is to say that the colors of the harmonic template will have good color harmony with the background image as well as with each other. In some embodiments, more than one harmonic scheme is selected, which results in more generated versions of the ad.

RECOLOR: Recolor overlaid ad elements to match the selected harmonic scheme. For text elements, select a text color within the harmonic scheme that is sufficiently far from the background color and/or offers sufficient luminosity contrast. For image elements: shift the hues to match the harmonic scheme. Recoloring can produce multiple versions of the same combination of ad elements positioned in the same places.

SELECT SAMPLE: The selection of a sample of all ad versions is an optional operation. Each of previously described operations of generate map, generate multiple versions, select harmonic scheme and recolor tend to increase the number of versions of the composite ad (that is, candidates for possible commercial use) being generated. This number may be too large to have a human viewer approve them one by one, or to conduct conclusive CTR (“click through rate”) analysis. A sample of all the generated ad versions can be created using one or more if the following methods: (i) by ensuring even coverage of the whole solution space; (ii) by choosing versions with best memorability (this may include object and scene semantics, semantic attributes, spacial envelope, histograms of oriented gradients); (iii) by scoring versions using a machine learning model (see discussion of the train predictor operation in the following paragraph); and/or (iv) by selecting versions randomly.

TRAIN PREDICTOR: A CTR predictor module is trained. As the different versions of the ad are being served, the recorded stats (for example, click-throughs) are used to train a machine learning model. Features can include some of the same features used in the memorability literature, plus the relative positions and characteristics of the overlaid ad elements. The model can then be used in the select sample operation (see previous paragraph) to select some of the ad versions with the highest predicted CTRs.

ITERATE: Based on the performance of the versions selected in the select sample operations (discussed above), a new sample can be generated regularly to focus on the most productive parts of the solution space, use the new output from the CTR predictor after re-training it with new data, or try a new set of random versions. Various hill-climbing approaches can be used.

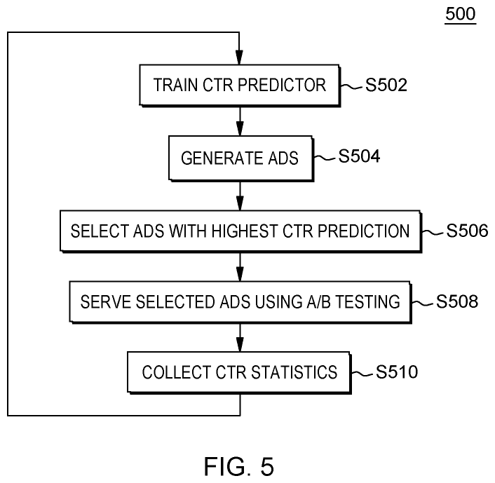

FIG. 5 shows flow chart 500 which shows a method according to the present invention. Processing begins at operation S502 where a CTR predictor (that is a computer based machine learning module) is trained. Processing proceeds to operation S504 where draft advertisements (sometimes herein called advertisement candidates) are generated based, in part, upon the training the CTR predictor received at operation S502. Processing proceeds to operation S506 where selected advertisement(s) are selected from the larger group of candidate advertisements based, at least in part, on CTR prediction values respectively corresponding to the candidate advertisements. Processing proceeds to operation S508 where the selected ads are served to potential customers using A/B testing. As the term is used herein, A/B testing is defined to mean a randomized experiment with two variants, A and B—it includes application of statistical hypothesis testing or “two-sample hypothesis testing” as used in the field of statistics. Processing proceeds to operation S510 where CTR statistics for the served, selected advertisements are collected based on “click throughs” of the selected advertisements by the potential customers to whom the selected advertisements were served. Processing then loops back to operation S502, where further training of the CTR predictor is performed based on the collected CTR statistics collected at operation S510.

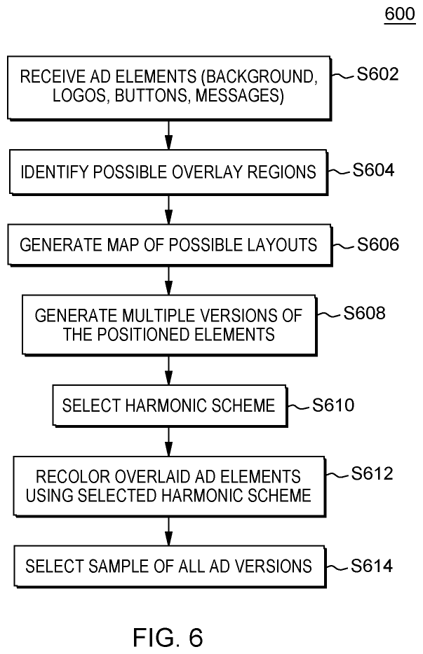

FIG. 6 shows flow chart 600 which shows a method according to the present invention. Processing begins at operation S602 where a set of visual elements for an advertisement (for example, background patter or image, logos, buttons, text) are received. Processing proceeds to operation S604 where machine logic identifies possible overlay regions. Processing proceeds to operation S606 where machine logic generates a map of possible layouts based upon the set of visual elements received and the identification of possible overlay regions. Processing proceeds to operation S608 where machine logic generates multiple candidate versions of the positioned visual elements based on the map of possible layouts. Processing proceeds to operation S610 where machine logic selects a harmonic color scheme for the multiple candidate versions of the advertisement. Processing proceeds to operation S612 where machine logic colors (or recolors) the multiple candidate versions of the advertisement to obtain multiple colored candidate versions of the advertisement. Processing proceeds to operation S614 where machine logic (or, in some embodiments, a human individual selects a sample of selected advertisements for actual use from the larger set of multiple colored candidate versions of the advertisement.

Some embodiments of the present invention may include one, or more, of the following features, characteristics and/or advantages: (i) generate different versions of the same advertisement that are much more than reformatted; (ii) provides many variations of the same ad to identify which ones get the best click-through rates; (iii) the ads can be served in any page context; (iv) generates versions of an advertisement without a template; (v) identify advertisement regions automatically; (vi) actually analyzes the background image for possible overlay regions; (vii) uses harmonic color schemes to recolor ad elements (including images); (viii) considers color as one of the main drivers of user attention; (ix) does not treat color as a random attribute; (x) uses an auto-encoder to select the areas of the ad generation latent space that will produce the highest CTR; (xi) generates ads from scratch; (xii) identifies overlay regions within a background image; (xiii) uses harmonic color schemes to recolor ad elements; (xiv) generates multiple ads for A/B testing; and (xv) uses an iterative ad generation process based on CTR.

Some embodiments of the present invention may include one, or more, of the following features, characteristics and/or advantages: (i) dynamically assembles graphic elements (background images, logos, buttons, text labels) to form multiple images; (ii) assembles graphic elements (background images, logos, buttons, text labels) to provide as many variations of the same ad as possible, and eventually identify which ones get the best click-through rates; and/or (iii) uses algorithms to determine image saliency or widget placement on a background image.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer implemented method (CIM) comprising:
receiving a visual elements data set including a plurality of visual elements for a first advertisement;
determining, by machine logic, a set of layout(s) for the plurality of visual elements;
determining, by machine logic, a set of color scheme(s) including a plurality of colors, where each color scheme has a color harmony value that is relatively large;
for each given layout of the set of layout(s) and each given color scheme of the set of color scheme(s), coloring, by machine logic, the given layout according to the given color scheme to generate a set of colored first advertisement version(s); and
testing the performance of the set of colored first advertisement version(s).

2. The CIM of claim 1 where the determination of the set of color scheme(s) includes determining that each given color scheme of the set of color scheme(s) has a color harmony value above a predetermined threshold.

3. The CIM of claim 1 wherein the testing of the performance includes, for each given colored first advertisement version, testing by a click through rate predictor.

4. The CIM of claim 1 wherein the testing of the performance includes, for each given colored first advertisement version, testing by A/B testing.

5. The CIM of claim 1 further comprising:
training and intermittently re-training a click through rate predictor;
wherein the testing of the performance includes:
for each given colored first advertisement version of the set of colored first advertisement version(s), testing the given colored first advertisement version by the click through rate predictor to obtain a subset of colored first advertisement version(s), and
for each given colored first advertisement version of the subset of colored first advertisement version(s), serving the given colored first advertisement version using A/B testing.

6. A computer program product (CPP) comprising:
a machine readable storage device; and
computer code stored on the machine readable storage device, with the computer code including instructions for causing a processor(s) set to perform operations including the following:
receiving a visual elements data set including a plurality of visual elements for a first advertisement,
determining, by machine logic, a set of layout(s) for the plurality of visual elements,
determining, by machine logic, a set of color scheme(s) including a plurality of colors, where each color scheme has a color harmony value that is relatively large,
for each given layout of the set of layout(s) and each given color scheme of the set of color scheme(s), coloring, by machine logic, the given layout according to the given color scheme to generate a set of colored first advertisement version(s), and
testing the performance of the set of colored first advertisement version(s).

7. The CPP of claim 6 where the determination of the set of color scheme(s) includes determining that each given color scheme of the set of color scheme(s) has a color harmony value above a predetermined threshold.

8. The CPP of claim 6 wherein the testing of the performance includes, for each given colored first advertisement version, testing by a click through rate predictor.

9. The CPP of claim 6 wherein the testing of the performance includes, for each given colored first advertisement version, testing by A/B testing.

10. The CPP of claim 6 wherein the computer code further includes instructions for causing the processor(s) set to perform the following operation(s):
training and intermittently re-training a click through rate predictor;
wherein the testing of the performance includes:
for each given colored first advertisement version of the set of colored first advertisement version(s), testing the given colored first advertisement version by the click through rate predictor to obtain a subset of colored first advertisement version(s), and
for each given colored first advertisement version of the subset of colored first advertisement version(s), serving the given colored first advertisement version using A/B testing.

11. A computer system (CS) comprising:
a processor(s) set;
a machine readable storage device; and
computer code stored on the machine readable storage device, with the computer code including instructions for causing the processor(s) set to perform operations including the following:
receiving a visual elements data set including a plurality of visual elements for a first advertisement,
determining, by machine logic, a set of layout(s) for the plurality of visual elements,
determining, by machine logic, a set of color scheme(s) including a plurality of colors, where each color scheme has a color harmony value that is relatively large,
for each given layout of the set of layout(s) and each given color scheme of the set of color scheme(s), coloring, by machine logic, the given layout according to the given color scheme to generate a set of colored first advertisement version(s), and
testing the performance of the set of colored first advertisement version(s).

12. The CS of claim 11 where the determination of the set of color scheme(s) includes determining that each given color scheme of the set of color scheme(s) has a color harmony value above a predetermined threshold.

13. The CS of claim 11 wherein the testing of the performance includes, for each given colored first advertisement version, testing by a click through rate predictor.

14. The CS of claim 11 wherein the testing of the performance includes, for each given colored first advertisement version, testing by A/B testing.

15. The CS of claim 11 wherein the computer code further includes instructions for causing the processor(s) set to perform the following operation(s):
training and intermittently re-training a click through rate predictor;
wherein the testing of the performance includes:
for each given colored first advertisement version of the set of colored first advertisement version(s), testing the given colored first advertisement version by the click through rate predictor to obtain a subset of colored first advertisement version(s), and
for each given colored first advertisement version of the subset of colored first advertisement version(s), serving the given colored first advertisement version using A/B testing.
